(19) United States
(12) Patent Application Publication
(10) Pub. No.: US 2004/0197534 A1
(43) Pub. Date: Oct. 7, 2004

(54) Composite vehicle panels

(76) Inventors: Kenneth C. Miller, Yarmouth, ME (US); Thomas C. Rand, Poland Spring, ME (US); James S Carter JR., Rumford, ME (US)

Correspondence Address: Curtis H. Castleman, The Gates Corporation, MS: 31-4-1-A3, 900 S. Broadway, Denver, CO, 80209, US

(21) Appl. No.: 10/665,030

(22) Filed: Sep. 16, 2003

Related U.S. Application Data
(60) Provisional application No. 60/411,011, filed on Sep. 16, 2002.

(51) Int. Cl. B32B 27/12; D04H 1/00; D04H 3/00; B32B 3/00; B32B 27/14

(52) U.S. Cl. 428/195.1; 428/196; 442/413; 442/394

(57) ABSTRACT

A composite vehicle panel made up of at least three layers of materials including a first layer, a middle layer, and a second layer, wherein the first layer and the second layer are bonded through at least one aperture in the middle layer, thereby allowing the manufacture of the composite panel in a single-step process.

### REFERENCE TO RELATED APPLICATIONS

This application claims priority from U.S. provisional application No. 60/411,011 filed Sep. 16, 2002.

### TECHNICAL FIELD

This invention relates to the field of manufacturing vehicle panels, more particularly, this invention relates to a fabric and/or sheeting material covered composite panel and a method for manufacturing a fabric and/or sheeting material covered composite panel of at least three layers that is fastened together through apertures in the middle layer.

### BACKGROUND OF THE INVENTION

Transportation vehicles, such as automobiles, vans, trucks, sport utility vehicles, buses, airplanes, boats, and trains, often have a need for panels that are covered by a fabric and/or sheeting material. Often, there is a requirement that these panels have sufficient structural integrity to handle various loads, for example the floor panel of a trunk of an automobile, which requires a rigid layer within the panel. It is also often desired to have various fabric or sheeting materials attached to a panel to perform various functions. The most common types of fabric and sheeting used are carpeting on one side of the panel to give a “finished” appearance, and an insulating fabric or substrate made from a sheeting material on the other side of the panel to assist with acoustic and/or temperature control.

To construct such a composite panel, it has typically been required to attach a fabric or sheeting layer to one side of a rigid layer with glues, hot melt adhesives, laminating processes, or by mechanical means such as staples or clips, then attach the other fabric or sheeting layer to the other side of the rigid layer in the same manner. Another process that has been utilized is ultrasonically welding the two material layers to each other, then attaching the composite material layer to the rigid layer in a manner discussed above. The problem with both of these processes is that they require a minimum of two steps to manufacture a 3-layer composite panel, and therefore decrease efficiency and increase costs.

U.S. Pat. No. 6,296,076 to Hiers et al discloses a needled composite acoustical barrier, with a non-woven first layer, a non-woven second layer, and an intermediate barrier layer having a substantially continuous film of high-density needleable polymeric material. However, the intermediate layer does not have, nor is there any suggestion to provide, apertures in it to allow for the first and second layers to bond directly with each other.

### SUMMARY OF THE INVENTION

Accordingly, it is an aspect of this invention to provide a composite vehicle panel made up of at least three layers of materials including a first layer, a middle layer, and a second layer, wherein the first layer and the second layer are bonded together through at least one aperture formed in the middle layer.

It is another aspect of this invention to provide a method of manufacturing a composite vehicle panel made up of at least three layers of materials including a first layer, a middle layer, and a second layer, including the step of bonding the first layer and the second layer together through at least one aperture in the middle layer. The manufacture of the composite panel may be effected in a single-step process.

The above and other features and advantages of the invention will be apparent in the following detailed description.

### BRIEF DESCRIPTION OF THE DRAWINGS

FIG. 1 is an exploded perspective view of exemplary elements that are combined to form a composite vehicle panel in accordance with the present invention; and

FIG. 2 is a section view of a completed composite panel in accordance with the present invention, taken at 2-2 of FIG. 1.

### DETAILED DESCRIPTION OF THE PREFERRED EMBODIMENT

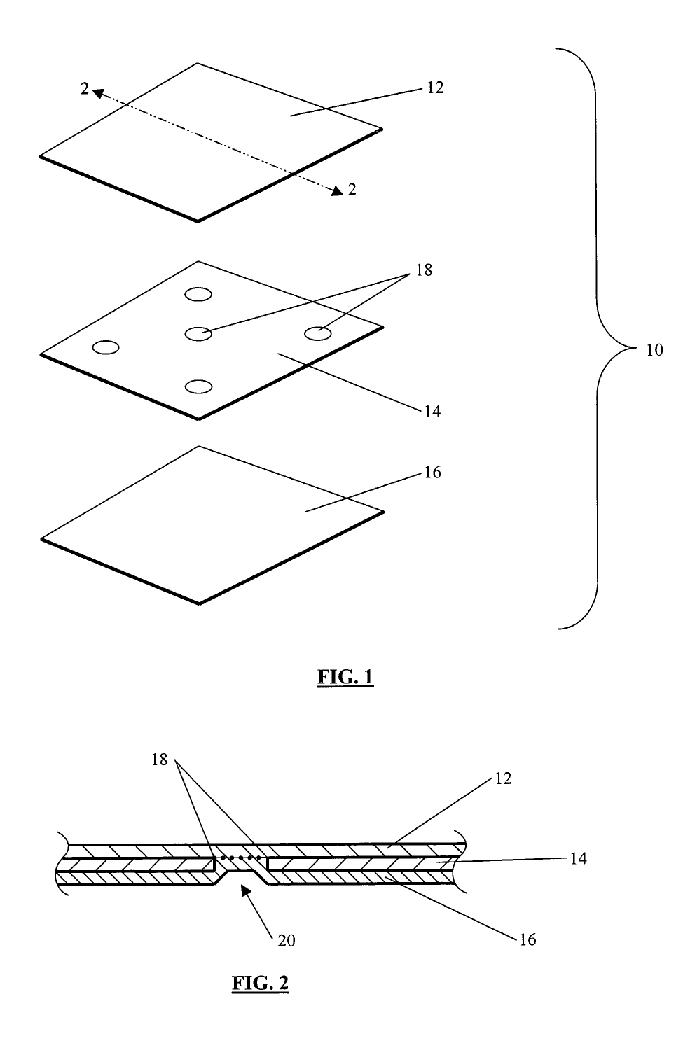

Referring to FIG. 1, a composite panel (shown generally as 10) of the present invention is comprised of at least three layers, a first layer 12, a middle layer 14, and a second layer 16. Either or both of first layer 12 and second layer 16 can be a fabric formed from a material such as, but not limited to, wool, cotton, acrylic, polybenzimidazole, aramid, rayon or other cellulosic materials, carbon, glass, novoloid fibers, polyethylene, polypropylene, polyester, nylon, polyphenylene sulfide, polyether sulfone, polyether-ether ketone, vinyon, other thermoplastic materials, as well as any combination of two or more of the foregoing. Alternatively, either or both of first layer 12 and second layer 16 can be formed of a sheeting material formed from material such as, but not limited to, thermoplastic olefin (TPO), rubber modified polypropylene, polyethylene homopolymer and copolymer (HDPE, MDPE, LDPE, solid and foam), ethylene-propylene ethylidene (EPDM), filled ethylene vinyl acetate (EVA), acrylic rubber, butadiene rubber, nitrile-butadiene rubbers, styrene-butadiene rubbers, isoprene rubbers, butyl rubbers, nitrile rubbers, polyurethane rubbers, natural rubber, polyvinyl chloride (PVC), polyurethane (solid and foam), polyester, polystyrene, acrylonitrile butadiene styrene (ABS), polyamides, ionomers, acrylics, flouropolymers, polycarbonates, bituminous material, metal materials, as well as any combination of two or more of the foregoing. Further, the first and second layers may be made of the same or different material from each other, may be of high or low density, may be of any thickness that allows for an adequate bond, and may be a woven, knit, non-woven, sheeting, or film material. Additionally, the first layer 12 and second layer 16 may be a single piece of continuous fabric or sheeting material that is wrapped around the middle layer 14 and bonded to itself.

It is contemplated that middle layer 14 may be comprised of a substantially rigid material such as wood, wood fiberboard, plastic, or metal, to provide structural support to the composite panel 10. However other rigid or non-rigid materials may be utilized to form the middle layer 14 depending on the desired properties for the composite panel 10, the only requirement being that the middle layer 14 need not be bonded (and preferably is not bonded) to either the first layer 12 or the second layer 16, and be sufficiently rigid enough to have at least one aperture 18.

Middle layer 14 has at least one aperture 18 so that the first layer 12 and the second layer 16 can be bonded to each other through the aperture to provide structural integrity to the composite panel. The aperture 18 is preformed and in existence prior to the bonding of the first and second layers. It is contemplated that the middle layer 14 can have more than one aperture 18, and that their location may be designed to correspond with desired characteristics, such as structural requirements and insulating requirements.

The first layer 12 and second layer 16 can be bonded together in any manner that provides the desired holding strength. Examples of bonding methods include, but are not limited to, ultrasonic welding, RF welding, glues, hot melt adhesives, laminating processes, stitching, needle punching, or by mechanical means such as staples or clips, or any combination thereof. Ultrasonic welds are common in the art and are effected generally by an electrical power supply that provides high frequency electrical power at a predetermined ultrasonic frequency, dependent upon the material to be welded, to an electroacoustic transducer. The resulting mechanical vibrations from the transducer are coupled to the input surface of a horn, which like the transducer, is dimensioned to be mechanically resonant at the predetermined frequency. The opposite end of the horn, forming the output surface, together with an oppositely disposed anvil form a gap or nip (weld station) through which material to be welded is placed. Force means effective upon the horn or upon the anvil urge the material and the horn's output surface into contact with one another, whereby the dissipation of the ultrasonic energy provided by the horn to the material causes the material to soften and subsequently to solidify as the material leaves the weld station, thus causing a weld.

Radio frequency (“RF”) welding, also known as high frequency sealing, or dielectric heat sealing, is similar to ultrasonic welding and is also common in the art to bond thermoplastic materials and may be used in the subject invention. An RF welder directs a large amount of electrical energy into the work area, which causes the molecules of the material being welded to oscillate, creating heat. A combination of this heat and pressure exerted by the press portion of the sealer causes the material to bond. Both the ultrasonic welding and the RF welding may additionally be accomplished by providing a film layer in between the first and second layers, with the film layer being susceptible to the welding method used and causing a bond, and thereby allowing the first and second layers to bond directly to each other even if the materials comprising the first and second layers are not susceptible to the welding method used.

An example of a lamination process that may be used is one that utilizes an adhesive comprising a mixture of acrylic and polyurethane with a cross linkage catalyst which reacts with active hydrogen groups in the material, heated for about one minute between 180° F. and 220° F. to dry and cure the lamination.

It is important to note that in the preferred embodiment, the bonding methods contemplated in this invention bond the first and second layers together, and the middle layer 14 is not actually bonded to either layer, but is held in place by the first and second layers being bonded through one or more aperture 18. Therefore, the “fit” of the three layers is dependent upon the area of the bonded surfaces in relation to the area of the aperture. In the preferred embodiment, at least one of the first or second layers is a fabric comprised of thermoplastic fibers, so that an ultrasonic weld creates a solid bond. This embodiment allows for a relatively quick manufacturing process, as there is no curing, setting, or drying time requirement as is necessary with most adhesives. In the alternative, it is contemplated that a thermoplastic film may be placed in between the first and second layers to facilitate a solid bond upon ultrasonic welding.

Although FIG. 1 illustrates three layers of materials to form the composite panel, it is contemplated that the composite panel of the present invention may be comprised of more than three layers. These additional layers may bond directly with the first or second layers, otherwise the additional layers must have at least one aperture that aligns with an aperture in the middle layer so that the first and second layers can bond to each other through the aligned apertures. It is preferred that any additional layers be interposed in between the first and second layers, but it is contemplated that additional layers may be bonded on either side of the first or second layers. Additionally, although FIG. 1 represents the layers as being the same size and shape, it is contemplated that the various layers that comprise a composite panel of the present invention do not need to be the same size and/or shape, as a slight overlap of fabric or other material may be desired in certain applications. Similarly, the edges of the first layer 12 can be bonded to the edges of the second layer 16, but are not required to do so.

FIG. 2 is a sectional view taken at 2-2 of FIG. 1. First layer 12 and second layer 16 are bonded together (shown generally as 20) through an aperture 18 of the middle layer 14. The appearance of a bond 20 is dependent on the fabric that is being bonded together, and the method of bonding. Therefore, material may or may not have a compressed appearance as illustrated in FIG. 2. It is contemplated that an ultrasonic weld of the preferred embodiment can allow a finished appearance on at least one side of the composite vehicle panel, which is currently desired for vehicle panels used in vehicles. Examples of factors that affect the final appearance of bonded fabric or sheeting material include the material's thickness, density, compressibility, bonding method, and its resistance to being bonded.

To manufacture the composite vehicle panel of the present invention, it is preferred to first align the three layers adjacent to each other. Then, the first layer 12 and second layer 16 are bonded to each other at points that are contained within the apertures 18 of the middle panel 14. This process allows for panels of various shapes and sizes to be manufactured in a single-step process, and there is no requirement that the panels be laid on a flat surface.

Although a specific preferred embodiment has been described with reference to the accompanying drawings herein, it is to be understood that the invention is not limited to that precise embodiment, and that various changes and modifications may be effected by one skilled in the art without departing from the scope or spirit of the invention as defined in the appended claims. Moreover, the invention illustratively described herein may be practiced in the absence of any element that is not specifically disclosed herein.

What is claimed is:

1. A composite vehicle panel comprising;
a first layer;
a second layer;
a middle layer disposed between said first and second layers, and said middle layer having at least one aperture through which said first and second layers are bonded together.

2. The composite vehicle panel of claim 1 wherein said middle layer is comprised of a substantially rigid material.

3. The composite vehicle panel of claim 2 wherein said rigid material is wood fiberboard.

4. The composite vehicle panel of claim 1 wherein said first layer is comprised of a fabric.

5. The composite vehicle panel of claim 4 wherein said fabric is non-woven.

6. The composite vehicle panel of claim 4 wherein said fabric is selected from the group consisting of wool, cotton, acrylic, polybenzimidazole, aramid, rayon or other cellulosic materials, carbon, glass, novoloid fibers, polyethylene, polypropylene, polyester, nylon, polyphenylene sulfide, polyether sulfone, polyether-ether ketone, vinyon, and any combination of two or more of the foregoing.

7. The composite vehicle panel of claim 1 wherein said second layer is a sheeting material.

8. The composite vehicle panel of claim 7 wherein said sheeting material is selected from the group consisting of thermoplastic olefin (TPO), rubber modified polypropylene, polyethylene homopolymer and copolymer (HDPE, LDPE, solid and foam), ethylene-propylene ethylidene (EPDM), filled ethylene vinyl acetate (EVA), acrylic rubber, butadiene rubber, nitrile-butadiene rubbers, styrene-butadiene rubbers, isoprene rubbers, butyl rubbers, nitrile rubbers, polyurethane rubbers, natural rubber, polyvinyl chloride (PVC), polyurethane (solid and foam), polyester, polystyrene, acrylonitrile butadiene styrene (ABS), polyamides, ionomers, acrylics, flouropolymers, polycarbonates, bituminous material, metal material, and any combination of two or more of the foregoing.

9. The composite vehicle panel of claim 1 wherein;
said first layer is a fabric; and
said second layer is a sheeting material.

10. The composite vehicle panel of claim 1 wherein said first and second layers are bonded together by ultrasonic welding, radio frequency (RF) welding, glues, hot melt adhesives, laminating processes, stitching, needle punching, or by mechanical means such as staples or clips.

11. A method of manufacturing a composite vehicle panel, said method comprising the steps of:
disposing a middle layer between a first layer and a second layer, the middle layer having an aperture; and
bonding the first layer to the second layer through the aperture.

12. The method of manufacturing a composite vehicle panel of claim 11, said method further comprising the step of:
disposing at least one additional layer of material between the first and second layers.
